(19) United States
(12) Patent Application Publication
(10) Pub. No.: US 2026/0189800 A1
(43) Pub. Date: Jul. 2, 2026

(54) ELECTRONIC DEVICE, METHOD FOR CONTROLLING ELECTRONIC DEVICE, AND STORAGE MEDIUM

(71) Applicant: Panasonic Intellectual Property Management Co., Ltd., Osaka (JP)

(72) Inventors: Takashi OSHIRO, Osaka (JP); Yusaku NAKAMURA, Osaka (JP); Mitsuhiro KIZU, Hyogo (JP); Masamitsu MURASE, Kyoto (JP); Motoka AISHIMA, Osaka (JP)

(21) Appl. No.: 19/544,358

(22) Filed: Feb. 19, 2026

Related U.S. Application Data
(63) Continuation of application No. PCT/JP2024/019049, filed on May 23, 2024.

(51) Int. Cl. H04N 23/74; G06K 7/14; G06V 30/14; G09G 5/10; H04N 23/63; H04N 23/71

(52) U.S. Cl. CPC H04N 23/74; G06K 7/1413; G06K 7/1417; G06V 30/1431; G09G 5/10; H04N 23/632; H04N 23/71; G09G 2320/0686

(57) ABSTRACT

An electronic device includes an imaging device that images a subject, a display, and a controller that controls the imaging device and the display. The display is provided on the same side as the imaging device in the electronic device, and displays a first region that irradiates the subject with illumination light and a second region that does not overlap the first region. The controller sets luminance of the display, sets lightness of the second region on the basis of the luminance of the display, acquires a first image of a subject by the imaging device, and acquires read information by analyzing the first image.

### CROSS REFERENCE TO RELATED APPLICATION

This application claims benefit of priority to International Application No. PCT/JP2024/019049, with an international filing date of May 23, 2024, the entire contents of which are incorporated herein by reference.

### TECHNICAL FIELD

The present disclosure relates to an electronic device, a method for controlling an electronic device, and a storage medium.

### BACKGROUND ART

There is an electronic device that acquires an image including a barcode or a QR code (registered trademark) with a camera and analyzes the image to read a coded character string.

### SUMMARY

The technique described in JP 6270854 B still has room for improvement in terms of providing a comfortable visual experience for a user and improving a success rate of barcode reading.

An object of the present disclosure is to provide an electronic device, a method for controlling an electronic device, and a storage medium that can provide a comfortable visual experience for a user and improve a success rate of barcode reading.

### Problems to be Solved by the Invention

In order to solve the above-described problems, the present disclosure provides an electronic device, a method for controlling an electronic device, and a storage medium.

An electronic device according to one aspect of the present disclosure includes an imaging device that images a subject, a display, and a controller that controls the imaging device and the display. The display is provided on the same side as the imaging device in the electronic device, and displays a first region that irradiates the subject with illumination light and a second region that does not overlap the first region. The controller sets luminance of the display, sets lightness of the second region on the basis of the luminance of the display, acquires a first image of a subject by the imaging device, and acquires read information by analyzing the first image.

In addition, a method for controlling an electronic device according to another aspect of the present disclosure is applicable to an electronic device, and a display of the electronic device displays a first region for irradiating a subject with illumination light and a second region not overlapping the first region. The control method includes setting luminance of the display, setting lightness of the second region on the basis of the luminance of the display, acquiring a first image of a subject by an imaging device of the electronic device, and acquiring read information by analyzing the first image.

Furthermore, a storage medium according to another aspect of the present disclosure is a non-transitory computer-readable storage medium in which a computer program is stored. When the computer program is executed by a processor, the above-described control method is realized.

In the present disclosure, according to the electronic device, the method for controlling an electronic device, and the storage medium, it is possible to provide the user with a comfortable visual experience and improve the success rate of barcode reading.

### BRIEF DESCRIPTION OF DRAWINGS

FIG. 1 is an example of a block diagram illustrating a configuration of an electronic device of a first embodiment;

FIG. 2A is a schematic diagram illustrating acquisition of read information by the electronic device of the first embodiment;

FIG. 2B is a schematic diagram illustrating a screen of a display of the electronic device of the first embodiment;

FIG. 3A is a schematic diagram illustrating acquisition of read information by the electronic device of the first embodiment;

FIG. 3B is a schematic diagram illustrating a screen of a display of the electronic device of the first embodiment;

FIG. 4 is a flowchart of an example of a method for controlling an electronic device of the first embodiment;

FIG. 5A is a schematic diagram illustrating a screen of the display of the electronic device of the first embodiment;

FIG. 5B is a schematic diagram illustrating a screen of the display of the electronic device of the first embodiment;

FIG. 5C is a schematic diagram illustrating a screen of the display of the electronic device of the first embodiment;

FIG. 6 is a flowchart of another example of the method for controlling an electronic device of the first embodiment;

FIG. 7A is a schematic diagram illustrating an example of a first region of the first embodiment;

FIG. 7B is a schematic diagram illustrating an example of a first region of the first embodiment;

FIG. 7C is a schematic diagram illustrating an example of a first region of the first embodiment;

FIG. 8 is a flowchart of an example of step S400 of a second embodiment;

FIG. 9 is a flowchart of another example of step S400 of the second embodiment;

FIG. 10 is a flowchart of an example of a method for controlling an electronic device of a third embodiment;

FIG. 11 is a flowchart of an example of a method for controlling an electronic device of a fourth embodiment;

FIG. 12 is a flowchart of an example of a method for controlling an electronic device of a fifth embodiment;

FIG. 13 is a schematic diagram illustrating halation of the fifth embodiment;

FIG. 14A is a schematic diagram illustrating an example of a first region of a sixth embodiment;

FIG. 14B is a schematic diagram illustrating an example of a first region of the sixth embodiment;

FIG. 14C is a schematic diagram illustrating an example of a first region of the sixth embodiment;

FIG. 14D is a schematic diagram illustrating an example of a first region of the sixth embodiment;

FIG. 14E is a schematic diagram illustrating an example of a first region of the sixth embodiment;

FIG. 14F is a schematic diagram illustrating an example of a first region of the sixth embodiment;

FIG. 15 is a flowchart of an example of a method for controlling an electronic device of a seventh embodiment;

FIG. 16 is a schematic diagram illustrating an example of a third region of the seventh embodiment;

FIG. 17 is a flowchart of another example of a method for controlling an electronic device of the seventh embodiment; and

FIG. 18 is a schematic diagram illustrating an example of a third region of the seventh embodiment.

### DETAILED DESCRIPTION

### Technical Concept

An electronic device, a method for controlling an electronic device, and a storage medium of the present disclosure can provide a comfortable visual experience for a user and improve the bar code reading success rate. The control method can be performed by the electronic device. Prior to describing a specific embodiment of the electronic device, the method for controlling an electronic device, and the storage medium according to the present disclosure, first, a technical concept described in the present disclosure will be described with reference to an example.

The electronic device includes an imaging device and a display provided on the same side, and also includes a controller that controls the imaging device and the display. The imaging device can generate an image by imaging a subject including a barcode, a QR code, and the like. The controller can analyze the image of the subject and acquire read information from the barcode or the like.

In the present example, when acquiring the read information from the subject, the controller sets the luminance of the display. For example, in response to the surrounding environment of the electronic device being dark, the luminance of the display is set to be relatively high in order to acquire a clear image. Then, the controller sets lightness of a part of a region displayed on the display on the basis of the luminance of the display. For example, the controller sets lightness of a background region such that the lightness of the background region decreases as the luminance of the display increases with respect to the background region other than the region where the illumination light is provided on the display. That is, the luminance of the display being set relatively high, the lightness of the background region is set relatively low. With this setting, some regions provide relatively bright illumination light due to an increase in luminance, and an increase in brightness of the entire display due to a decrease in lightness of the background region can be suppressed, so that a comfortable visual experience can be provided for the user. Therefore, even if the luminance of the display increases in a dark place, the user does not feel dazzled with respect to the display, and can easily perform the operation of causing the electronic device to read the barcode or the like, so that the time until the reading can be shortened.

Each of the embodiments described below illustrates an example of the present disclosure. Numerical values, shapes, configurations, steps, order of steps, and the like shown in each of the following embodiments are merely examples, and do not limit the present disclosure. Among the components in the following first embodiment, components not recited in the independent claim indicating the highest concept are described as optional components.

In each of the embodiments described below, modifications may be shown for specific elements, and appropriate combination of arbitrary configurations is included for other elements, and each effect is achieved in the combined configuration. In the embodiments, by combining the configurations of the respective modifications, the effects of the respective modifications are acquired.

In the following detailed description, the terms “first,” “second,” and the like are only used for description, and should not be understood as clearly expressing or implying relative importance or a rank of a technical feature. Features limited to “first” and “second” are intended to clearly express or imply the inclusion of one or more such features.

### First Embodiment

Hereinafter, an electronic device, a method for controlling an electronic device, and a first embodiment of a storage medium according to the present disclosure will be described in detail with reference to the drawings as appropriate.

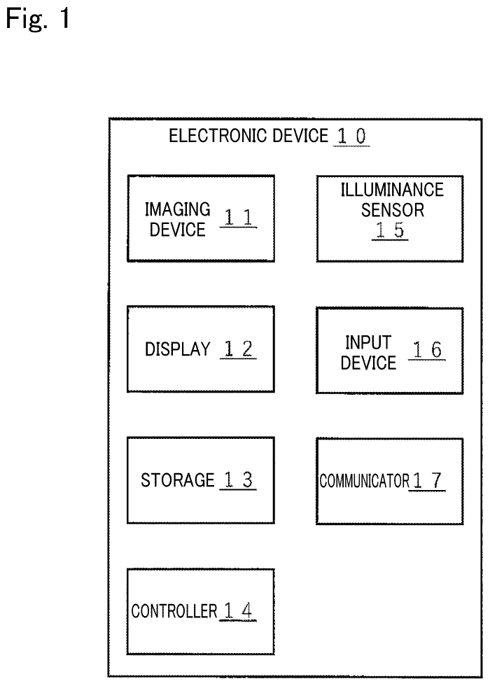

FIG. 1 is an example of a block diagram illustrating a configuration of electronic device 10 according to a first embodiment.

### <Electronic Device 10>

As illustrated in FIG. 1, an electronic device 10 includes at least an imaging device 11, a display 12, a storage 13, and a controller 14. The electronic device 10 may be a laptop computer including a notebook computer, a tablet terminal, a smartphone, or the like. Furthermore, the electronic device 10 may appropriately include at least one of an illuminance sensor 15, an input device 16, and a communicator 17 according to the application. Hereinafter, the technology of the present disclosure will be described using an example in which the electronic device 10 is a notebook personal computer, but the technology of the present disclosure is similarly applicable to other types of electronic devices 10.

The electronic device 10 of the present disclosure can acquire read information corresponding to a barcode or a character string by acquiring an image of a subject including the barcode or the character string by the imaging device 11 and analyzing the image.

### <Imaging Device 11>

The imaging device 11 is provided on the same side as the display 12 in the electronic device 10, and is provided, for example, on a side facing the user in normal use of the electronic device 10. The imaging device 11 is, for example, a camera or the like, and can generate an image by imaging a subject. The image generated by the imaging device 11 may be displayed on the display 12, may be stored in the storage 13, or may be analyzed by the controller 14. Note that the electronic device 10 may further include another imaging device provided on a side different from the display 12.

### <Display 12>

The display 12 is a device for providing visual information to a user, and can display various images and a graphical user interface (Graphical User Interface, GUI). The display 12 may be, for example, a display using a self-light emitting element such as an organic EL or a display using an LCD or a CRT.

The luminance of the display 12 refers to a degree of intensity of light emitted from the display 12. The luminance may be indicated in an absolute unit such as cd/m², nit, candela, or the like, or may be indicated in a plurality of stages (for example, 6 levels of 0 to 5 levels, 11 levels of 0 to 10 levels, 101 levels of 0 to 100 levels, three levels of “high”, “medium”, and “low”, and the like) in a range from the lowest luminance to the highest luminance of the display 12. The controller 14 can increase the luminance of the display 12, for example, by causing the display 12 to increase its output current.

When acquiring the read information, the display 12 displays a first region for irradiating the subject with the illumination light and a second region not overlapping the first region. In addition, the display 12 may display a preview screen (also referred to as a live-view image) of the imaging device 11 in a region different from the first region and the second region. The preview screen is a screen on which the content captured by the imaging device 11 can be checked in real time. The display 12 may display a GUI of an application (hereinafter, sometimes referred to as a “reading application”) for acquiring the read information, a GUI of an application not related to the acquisition of the read information, a GUI of an operating system (OS) of the electronic device 10, and the like. In one embodiment, the preview screen of the imaging device 11 is incorporated into a GUI of an application for acquiring read information, and is displayed in a third region of the display 12 together with the GUI.

### <Storage 13>

The storage 13 is a recording medium that records various information and control programs, and may be a memory that functions as a work area of the controller 14. The storage 13 is realized by, for example, a flash memory, a RAM, a solid state drive (SSD), a hard disk, other storage devices, or an appropriate combination thereof.

The storage 13 may store a reference, a parameter, a threshold, a comparison table, or a relational expression related to the setting of the luminance of the display 12 or the lightness of the second region. The storage 13 may store the image acquired by the imaging device 11, the analysis result for the image, the read information acquired from the image, and the user input acquired by the input device 16 or the communicator 17. Note that the image acquired by the imaging device 11 can be displayed on the preview screen of the display 12 without being stored in the storage 13.

The storage 13 may store a computer program for causing the controller 14 to execute the control method of the present disclosure. The storage 13 may be a non-transitory computer-readable storage medium in which the computer program is stored.

### <Controller 14>

The controller 14 is a controller that controls the entire electronic device 10. The controller 14 includes a general-purpose processor such as a CPU or an MPU that realizes a predetermined function by executing a program stored in the storage 13. The controller 14 implements various controls in the electronic device 10 by calling and executing a control program based on a control method. The controller 14 is not limited to one that realizes a predetermined function by cooperation of hardware and software, and may be a hardware circuit designed exclusively for realizing a predetermined function. That is, the controller 14 can be realized by various processors such as a CPU, an MPU, a GPU, an FPGA, a DSP, and an ASIC.

The controller 14 can execute the method for controlling an electronic device of the present disclosure and execute a function of acquiring read information from a subject.

### <Illuminance Sensor 15>

The illuminance sensor 15 is a sensor for detecting illuminance around the electronic device 10. The illuminance refers to a degree of brightness of a place where an object is illuminated by a light source, and the unit may be lux (lx). In one example, in the electronic device 10, the illuminance sensor 15 is provided on the same side as the imaging device 11 and the display 12.

### <Input Device 16>

The input device 16 is a device for receiving a user input from a user. The input device 16 may include, for example, a mouse, a keyboard, a touch panel, a touch pad, a switch, a button, a microphone, a camera, and the like. The input device 16 converts a content of a command or an operation received from the user into an electric signal and transmits the electric signal to the controller 14. Through the input device 16, it is possible to receive a start command of the reading function and a user input including information regarding an object to be read (that is, the subject of the imaging device 11) from the user. The information on the subject is, for example, information specifying at least one of the type, size, and reading position of the subject.

### <Communicator 17>

The communicator 17 can be connected to the Internet, and can communicate with an arbitrary server or information terminal by transmitting and receiving Internet packets on the Internet. The communicator 17 can communicate through a LAN, a WLAN, or a WWAN. For example, the communicator 17 may perform communication according to a standard such as Wi-Fi (registered trademark), IEEE802.2, IEEE802.3, 3G, or LTE to transmit and receive data. In addition to the Internet, the communicator 17 may perform communication using an intranet, an extranet, ISDN, VAN, a CATV communication network, a virtual dedicated network, a telephone line network, a mobile communication network, a satellite communication network, infrared rays, or Bluetooth (registered trademark). The communicator may include, for example, a circuit capable of communicating in accordance with the above-described standard.

The controller 14 can cooperate with a server and/or another electronic device via the communicator 17. In one example, the read information acquired from the subject is a character string representing a uniform resource locator (URL). After acquiring the read information, the controller 14 can access the URL via the communicator 17. In another example, the read information is an identification number that can identify the user. The controller 14 can specify the user by collating the database of the server via the communicator 17 with the identification number.

### <Subject 20>

The subject 20 may be an object including a one-dimensional code, an object including a two-dimensional code, or an identification card (identification document). The one-dimensional code may be, for example, a barcode. The two-dimensional code may be, for example, a QR code, a DataMatrix code, a MaxiCode code, or a PDF417 code. The identification card may be, for example, a driver's license, an Individual Number Card, an identification card, a health insurance card, a student card, a passport, a residence card, or a membership card. An object including a one-dimensional code or a two-dimensional code is basically a medium on which a code or the like is printed or attached. The media may be paper, plastic, metal, fabric, nonwoven, adhesive seals, and the like.

The read information acquirable from the subject 20 includes a character string coded in a one-dimensional code, a character string coded in a two-dimensional code, or a character string written on an identification card. The character string can represent various types of information, and may be, for example, a URL, an identification number, an authentication number, a membership number, a business code, a product code, a message, or the like.

### <Example of Usage Mode of Electronic Device 10>

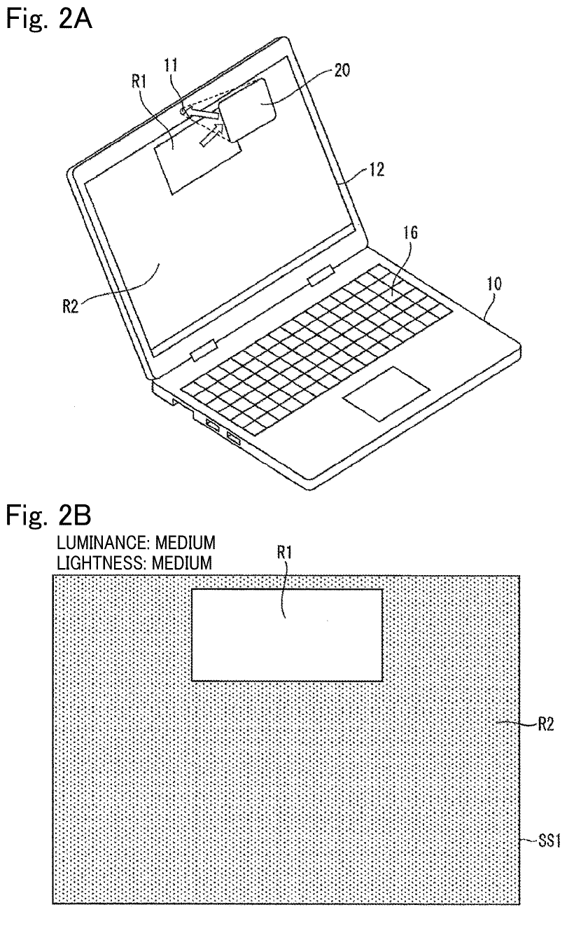

FIG. 2A is a schematic view illustrating acquisition of read information by the electronic device 10 of the first embodiment, and FIG. 2B is a schematic view illustrating a screen of the display 12 of the electronic device 10 of the first embodiment. In this example, the electronic device 10 is a notebook personal computer, and the subject 20 is a card on which a QR code is printed. In the electronic device 10, a camera which is an example of the imaging device 11 and a display which is an example of the display 12 are provided on the same side. The user brings the subject 20 close to the imaging device 11 and causes the imaging device 11 to image at least a portion of the QR code.

A first region R1 used as an illumination region and a second region R2 serving as a background region are displayed on the display 12. The first region R1 is provided on the imaging device 11 side in the display 12. In one example, the first region R1 is located in the vicinity of the imaging device 11 and is filled in white. The light emitted from the first region R1 hits the subject 20, is reflected, and is incident on the imaging device 11. Therefore, the display 12 provides the auxiliary light source to the subject 20 via the first region R1. In this example, the second region R2 is a region acquired by excluding the first region R1 from the displayable region (that is, the entire screen SS1 illustrated in FIG. 2B) of the display 12.

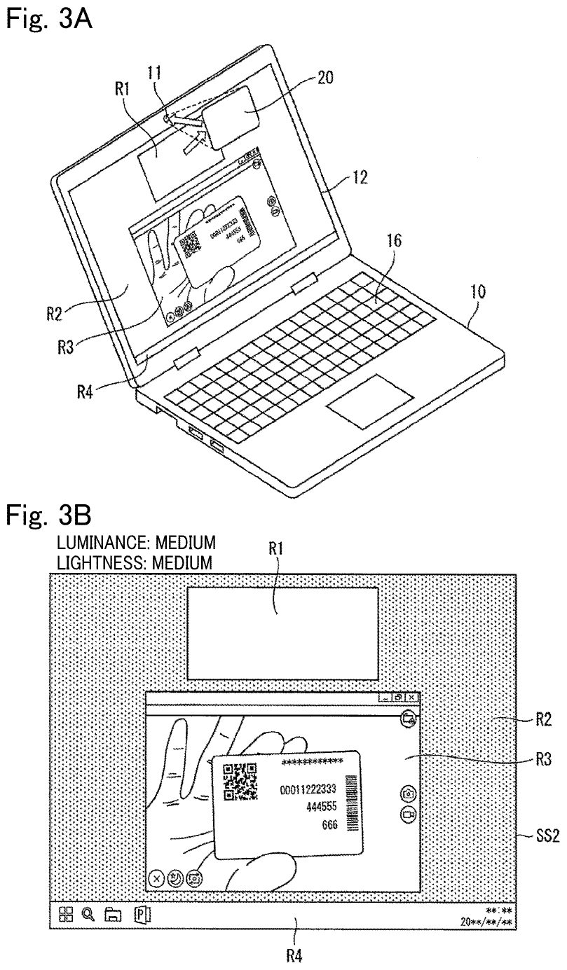

FIG. 3A is a schematic view of an electronic device 10 of another example, and FIG. 3B is a schematic view illustrating a screen of a display 12 of another example. In this example, a first region R1, a second region R2, a third region R3, and a fourth region R4 are displayed on a screen SS2 of the display 12. In the third region R3, a GUI of a reading application for acquiring read information from the subject 20 and a preview screen by the imaging device 11 are displayed. In the fourth region R4, an OS GUI and other applications are displayed. In this example, the second region R2 may be a region acquired by excluding the first region R1 from the displayable region of the display 12, or may be a region acquired by excluding the first region R1 and at least one of the second region R2, the third region R3, and the fourth region R4 from the displayable region.

### <Method for Controlling Electronic Device 10>

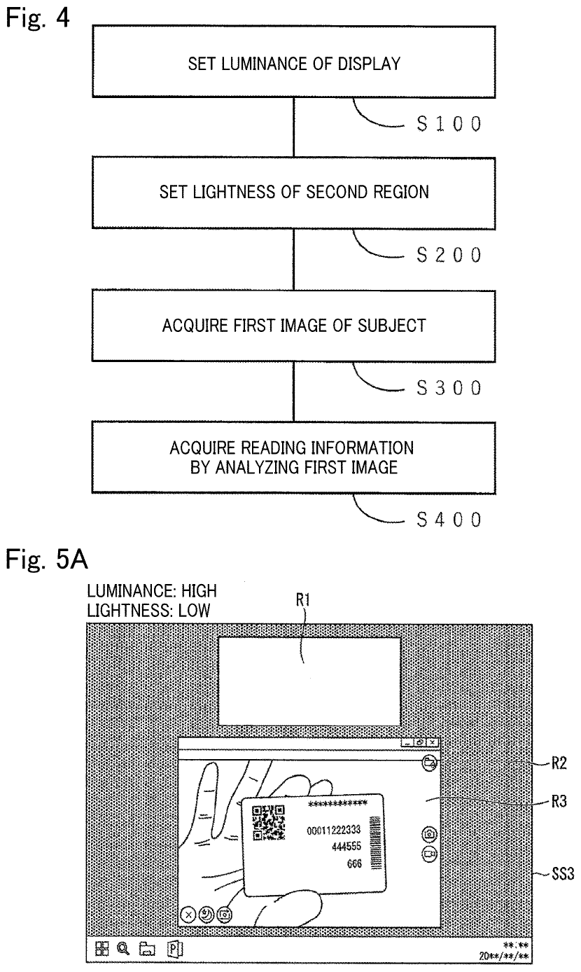

The controller 14 described above can execute a method for controlling the electronic device 10. FIG. 4 is a flowchart of an example of the method for controlling an electronic device according to the first embodiment.

The controller 14 sets the luminance of the display 12 (step S100). In one embodiment, the controller 14 sets the luminance of the display 12 such that the luminance of the display 12 increases as the illuminance detected by the illuminance sensor 15 decreases. For example, as compared with a case where the electronic device 10 is in a bright place and the illuminance of the surrounding environment is high, in response to the electronic device 10 being in a dark place and the illuminance of the surrounding environment is low, the controller 14 sets the luminance of the display 12 to be relatively high so as to provide brighter illumination light. In one example, the storage 13 stores a comparison table or a relational expression indicating the relationship between the illuminance and the luminance. The controller 14 can set the luminance of the display 12 on the basis of the comparison table or the relational expression.

Next, the controller 14 sets the lightness of the second region R2 on the basis of the set luminance of the display 12 (step S200). The lightness of the second region R2 is one of three attributes (hue, lightness, and saturation) of the color of the second region R2, and indicates the degree of brightness when the color is divided by brightness. As the lightness is higher, the color becomes brighter and approaches white, and as the lightness is lower, the color becomes darker and approaches black. For example, the controller 14 can increase the lightness of the display 12 by displaying an image including a color approaching white in the second region R2. Similarly, the controller 14 can decrease the lightness of the display 12 by displaying an image including a color close to gray or black in the second region R2.

The second region R2 may be filled with the same color, or may include a plurality of colors having the same lightness and different hue or saturation. In addition, the second region R2 may include a sub region including a color having lightness different from the lightness set in step S200.

When setting the lightness, the controller 14 may set an arbitrary numerical value within a settable range, may select from predetermined numerical values, or may select from predetermined stages (for example, three stages of “high”, “medium”, and “low”).

When the luminance of the display 12 is set high, the brightness of the entire display 12 increases. There is a possibility that the user feels dazzled by the brightness of the entire display 12. The brightness of the entire display 12 refers to a subjective and visual sensation produced in the user when light from the display 12 enters the user's eyes. For example, when the luminance of the display 12 becomes relatively high, the brightness of the entire display 12 becomes high. When the lightness of the image displayed on the screen of the display 12 increases or the proportion occupied by the portion having high lightness increases, the brightness of the entire display 12 also increases.

In step S200, the controller 14 sets the lightness of the second region R2 such that the lightness of the second region R2 decreases as the luminance of the display 12 increases. For example, the electronic device 10 being in a dark place, the controller 14 sets the luminance of the display 12 to be relatively high and sets the lightness of the second region R2 to be relatively low. With this setting, it is possible to improve the situation in which the user feels dazzled.

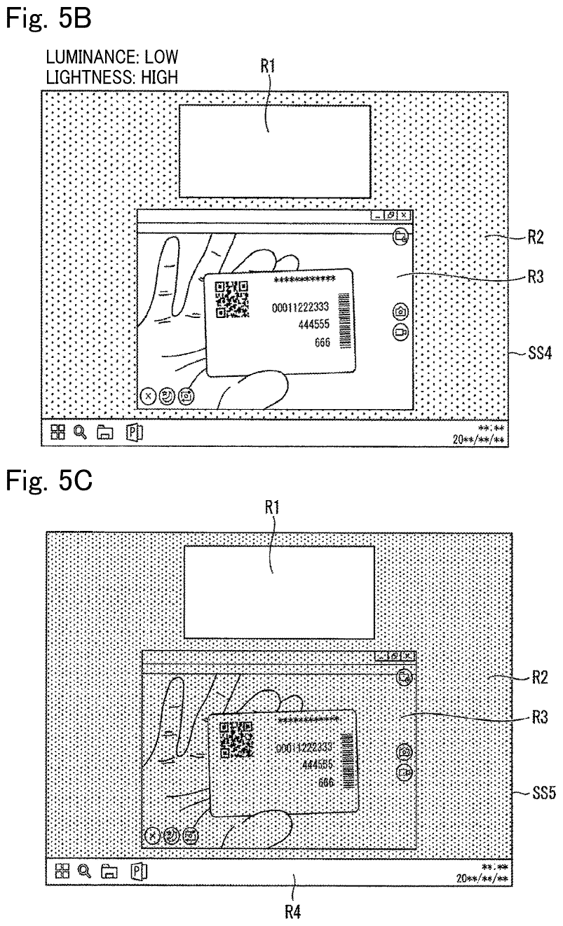

FIG. 5A is a schematic view illustrating a screen SS3 of the display 12 of the electronic device 10 of the first embodiment. In the example of FIG. 5A, the controller 14 sets the luminance of the display 12 to “high” in step S100, and sets the lightness of the second region R2 to “low” in accordance with the luminance “high” in step S200. As compared with the example of FIG. 3B (luminance “medium”, lightness “medium”), in the example of FIG. 5A, the lightness of the second region R2 decreases as the lightness of the display 12 increases. In this way, even if the luminance becomes relatively high, the brightness of the entire display 12 can be suppressed, and a comfortable visual experience can be provided to the user.

Similarly, in response to the electronic device 10 being in a bright place, the controller 14 sets the luminance of the display 12 to be relatively low and sets the lightness of the second region R2 to be relatively high. FIG. 5B is a schematic view illustrating a screen SS4 of the display 12 of the electronic device 10 of the first embodiment. In the example of FIG. 5B, the controller 14 sets the luminance of the display 12 to “low” in step S100, and sets the lightness of the second region R2 to “high” in accordance with the luminance “low” in step S200. As compared with the example of FIG. 3B (luminance “medium”, lightness “medium”), in the example of FIG. 5B, the lightness of the second region R2 increases as the lightness of the display 12 decreases. In this way, in a bright environment, power consumption can be suppressed with relatively low luminance, visual brightness can be maintained, and a comfortable visual experience can be provided to the user.

More specifically, the controller 14 can set the lightness of the second region R2 on the basis of the luminance of the display 12 so as not to give a sense of discomfort to the user with respect to the brightness of the entire display 12. For example, the lightness of the second region R2 may be set such that the brightness of the entire display 12 does not change so much even if the luminance changes.

In one embodiment, the storage 13 stores a comparison table or a relational expression indicating the relationship between the luminance of the display 12 and the lightness of the second region R2. The controller 14 can set the lightness of the second region R2 on the basis of the comparison table or the relational expression and the luminance set in step S100.

In one embodiment, the controller 14 sets the lightness of the second region R2 on the basis of the luminance of the display 12 so that the change in the brightness of the entire display 12 falls within a predetermined range. For example, the brightness of the entire display 12 is calculated by a predetermined mathematical expression relating to the luminance of the display 12 and the lightness of the second region R2. In this case, a lightness setting value or a lightness setting range corresponding to the luminance set in step S100 can be calculated so that the brightness is maintained in the predetermined range.

In order to affect the brightness of the entire display 12 by the setting of the lightness of the second region R2, the controller 14 may set the size of the second region R2 to be larger than the size of the first region R1. As illustrated in FIG. 3A, the entire region excluding the first region R1 from the displayable region of the display 12 may be set as the second region R2. As illustrated in FIGS. 3B, 5A, and 5B, a region acquired by excluding the first region R1, the third region R3, and the fourth region R4 from the displayable region of the display 12 may be set as the second region R2.

As illustrated in FIG. 5C, a region acquired by excluding the first region R1 and the fourth region R4 from the displayable region of the display 12 may be set as the second region R2. In the example of FIG. 5C, the controller 14 sets the lightness of the second region R2 that completely covers the third region R3 on the basis of the luminance of the display 12. In a screen SS5 illustrated in FIG. 5C, both the lightness of the third region R3 and the screen SS5 change together with the background portion (that is, a portion acquired by subtracting the third region R3 from the second region R2). In order to maintain the visibility of the preview screen, the change amount of the lightness with respect to the third region R3 may be smaller than the change amount of the lightness with respect to the background portion.

As described above, the controller 14 sets the luminance of the display 12 and the lightness of the second region R2 (steps S100 and S200). Next, the controller 14 causes the imaging device 11 to acquire a first image of the subject 20 with the set luminance and lightness (step S300). The first image is an image for analysis and can be stored in the storage 13 for later analysis.

The controller 14 acquires the read information by analyzing the acquired first image (step S400). For example, the controller 14 determines and detects whether a one-dimensional code, a two-dimensional code, or a character string written in a specific format exists in the first image. Then, the controller 14 acquires a character string coded into the one-dimensional code or the two-dimensional code as read information by using the identification program corresponding to the detected type of the code. Alternatively, the controller 14 recognizes a character string written in a specific format using a program such as optical character recognition (OCR) program, and acquires the recognized character string as read information. Note that the type of the barcode may be input by the user in advance, and the read information may be promptly acquired by the identification program corresponding to the input type.

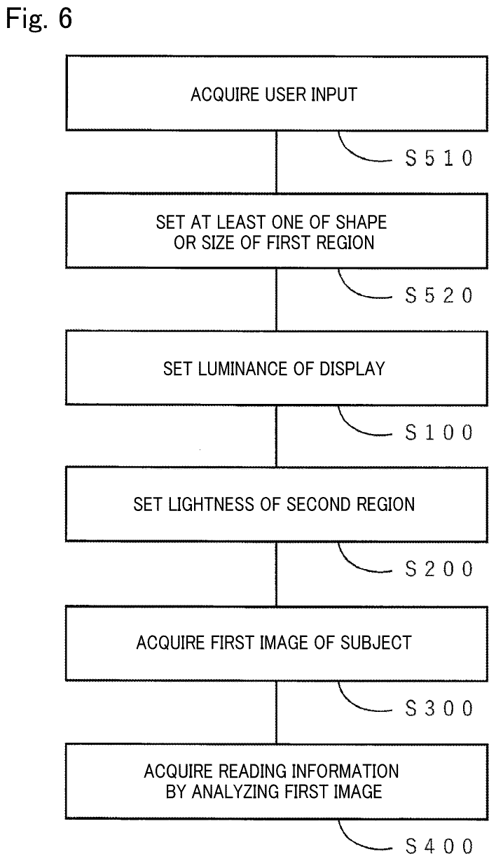

In one embodiment, the controller 14 can also set the first region R1 in order to acquire the read information from the subject 20. FIG. 6 is a flowchart of another example of the method for controlling an electronic device of the first embodiment.

For example, the user can specify the type (driver's license, health insurance card, passport, and the like) of the subject 20 via the GUI of the input device 16 and the reading application. The controller 14 causes the input device 16 to acquire a user input designating the type of the subject 20 (step S510), and sets at least one of the shape and the size of the first region R1 on the basis of the type of the subject 20 (step S520). Steps S510 and S520 are executed before step S300.

In this embodiment, the storage 13 stores a comparison table of the type of the subject 20 and the format of the subject 20. The controller 14 can acquire at least one of the shape and the size of the subject 20 by collating the comparison table. The controller 14 then sets the shape and size of the first region R1 in accordance with the acquired shape or size of the subject 20.

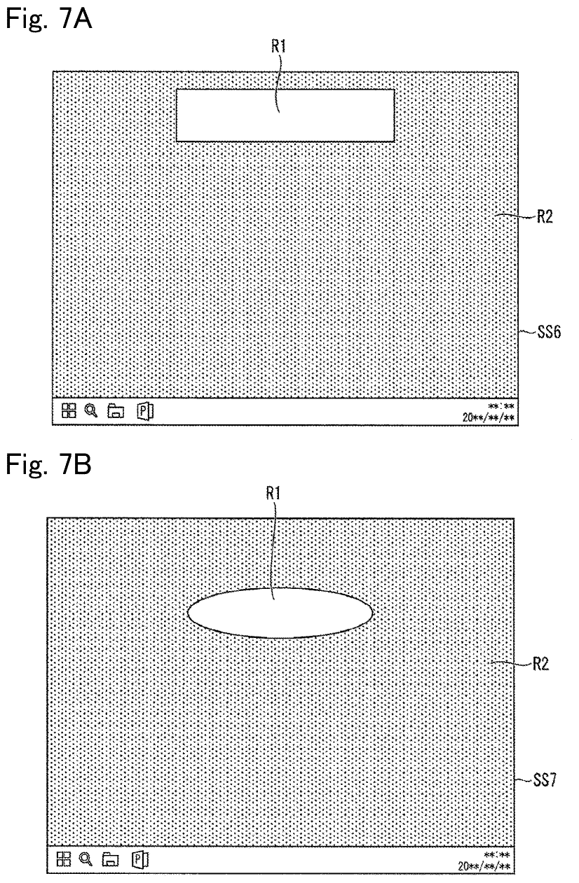

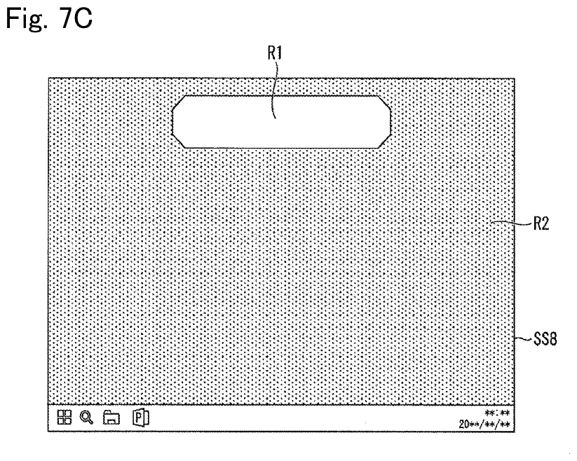

In one example, the first region R1 is set to have the same shape as the subject 20 or a shape surrounding the outer periphery of the subject 20. In one example, the first region R1 is set to have the same size as the subject 20, a size larger than the subject 20, or a size smaller than the subject 20. Like screens SS6 to SS8 illustrated in FIGS. 7A to 7C, the first region R1 can be set to have various shapes, sizes, or positions on the screen. For example, the first region R1 may be set to a rectangle adjacent to the imaging device 11 (FIG. 7A), may be set to an elliptical shape at a certain distance from the imaging device 11 (FIG. 7B), or may be set to a rectangle that is close to the imaging device 11 and has corners cut or rounded (FIG. 7C).

In addition, the position and size of the one-dimensional code, the two-dimensional code, or the character string (hereinafter, referred to as a one-dimensional code or the like) to be read can be acquired from the subject 20 by specification of the user input or collation of the comparison table by the user input. In this case, the controller 14 can set the position and size of the first region R1 so as to provide the illumination light to the position of the one-dimensional code or the like.

Furthermore, the controller 14 may set the color of the first region R1 on the basis of the illuminance around the electronic device 10, the color temperature or white balance of the preview screen of the imaging device 11, or the current time. For example, in the case of night, the controller 14 may set the color of the first region R1 to warm color.

In order to acquire the read information from the subject 20 without causing the user to feel dazzled, the controller 14 can set at least one of the size, shape, position, and color of the first region R1 to the fourth region R4, for example, in addition to the luminance of the display 12 and the lightness of the second region R2.

Thus, the processing of acquiring the reading information from the subject 20 is completed. In this way, by controlling the lightness of the second region R2 (background region) while providing the illumination light to the subject 20 through the first region R1, it is possible to provide a comfortable visual experience without giving a sense of discomfort to the user with respect to the brightness of the entire display 12. For example, even if the luminance of the display 12 increases in a dark place, the user does not feel dazzled with respect to the display 12, and can easily perform the operation of causing the electronic device 10 to read the one-dimensional code or the like, so that the time until reading can be shortened.

The present disclosure also provides a computer program and a storage medium for controlling the electronic device 10.

In one embodiment, a computer program used for causing the electronic device 10 to execute the above-described method for controlling the electronic device 10 is provided.

In one example, the computer program described above is stored in a non-transitory computer-readable storage medium. When the computer program is read and executed by the controller 14 of the electronic device 10, the above-described control method is realized.

According to the configuration of the electronic device 10, the method for controlling the electronic device 10, the computer program, and the recording medium, a comfortable visual experience can be provided to the user by controlling the lightness of the second region R2 (background region) while providing the illumination light to the subject 20.

### Second Embodiment

### <Luminance Change Upon Analysis Failure>

In a second embodiment, when the analysis of the first image fails, the controller 14 changes the luminance of the display 12 and the lightness of the second region R2, and then performs the acquisition and analysis of the first image again.

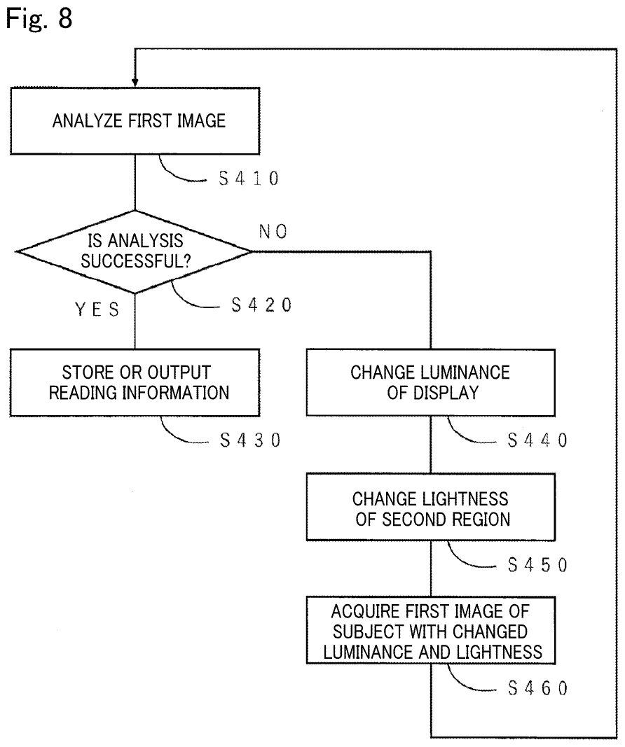

FIG. 8 is a flowchart of an example of step S400 of the second embodiment. In the second embodiment, the controller 14 executes steps S100 to S300 illustrated in FIG. 4, and further executes step S400 including steps S410 to S460 illustrated in FIG. 8.

In step S400, the controller 14 analyzes the first image acquired in step S300 (step S410). Next, the controller 14 determines whether analysis has succeeded (step S420). In response to the read information being acquired by analyzing the first image, that is, in response to the read information of the character string being acquired from the one-dimensional code or the like, the controller 14 determines that the analysis has succeeded. On the other hand, in response to the read information not being acquired by analyzing the first image, the controller 14 determines that the analysis has failed.

In response to the analysis being successful, the controller 14 stores or outputs the read information (step S430). For example, the controller 14 may store the read information in the storage 13, may output the read information to the display 12 to display the read information, or may output the read information to the communicator 17 to transmit the read information to the server or another information terminal.

In response to the analysis not being successful, the controller 14 changes the luminance of the display 12 (step S440), and changes the lightness of the second region R2 on the basis of the changed luminance (step S450). For example, the controller 14 may increase the luminance of the display 12 and decrease the lightness of the second region R2, or may decrease the luminance of the display 12 and increase the lightness of the second region R2.

The controller 14 causes the imaging device 11 to acquire the first image of the subject 20 again with the changed luminance and lightness (step S460). Then, the controller 14 returns to step S410, and attempts to acquire read information by analyzing the first image acquired with the changed luminance and lightness.

As described above, in the second embodiment, by changing the luminance, the illumination environment for the subject 20 is changed to promote successful analysis. In addition, the controller 14 also changes the lightness in accordance with the change in luminance so as not to give a sense of discomfort to the user with respect to the brightness of the entire display 12 due to the change in luminance.

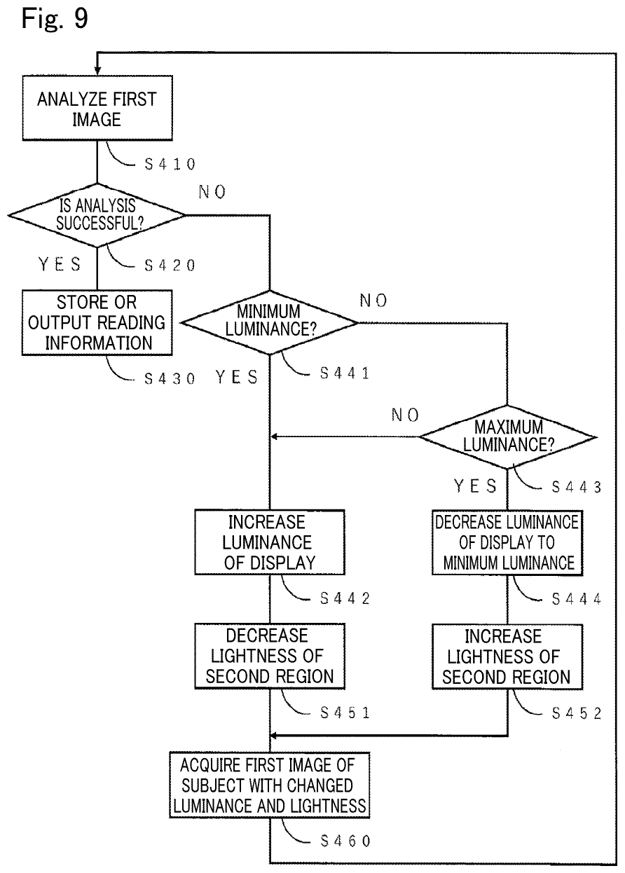

In one embodiment, the controller 14 changes the stepwise luminance within a range from the minimum luminance to the highest luminance of the display 12. For example, as illustrated in FIG. 9, the controller 14 changes to increase the luminance stepwise within a range from the minimum luminance to the maximum luminance of the display 12.

FIG. 9 is a flowchart illustrating another example of step S400 in the second exemplary embodiment. The contents of steps S410 to S430 and S460 in FIG. 9 are similar to those of steps S410 to S430 and S460 in FIG. 8, and the detailed description thereof will be omitted. Steps S441 to S444 in FIG. 9 correspond to step S440 in FIG. 8, and steps S451 and S452 in FIG. 9 correspond to step S450 in FIG. 8.

In the embodiment of FIG. 9, when the luminance of the display 12 is changed, the controller 14 determines whether the current value of the luminance (that is, the luminance currently set on the display 12) is the lowest luminance of the display 12 (step S441). In response to the current value of the luminance being the lowest luminance, the controller 14 increases the luminance of the display 12 (step S442), and decreases the lightness of the second region R2 on the basis of the increased luminance (step S451).

In response to the current value of the luminance not being the lowest luminance, the controller 14 further determines whether the luminance is the highest luminance of the display 12 (step S443). In response to the current value of the luminance being the highest luminance, the controller 14 decreases the luminance of the display 12 to the lowest (minimum) luminance (step S444), and increases the lightness of the second region R2 on the basis of the decreased luminance (step S452).

In response to the current value of the luminance being neither the lowest luminance nor the highest luminance (“NO” in step S443), the controller 14 executes steps S442 and S451 to increase the luminance of the display 12 stepwise.

In one embodiment, in step S440, the controller 14 changes to decrease the luminance stepwise within a range from the minimum luminance to the maximum luminance of the display 12. In this case, when the current value of the luminance is neither the lowest luminance nor the highest luminance, the controller 14 decreases the luminance of the display 12 stepwise, and increases the lightness of the second region R2 on the basis of the decreased luminance. When it is determined that the current value of the luminance is the lowest luminance, the luminance of the display 12 is increased to the highest luminance.

In one embodiment, the controller 14 randomly changes the luminance within a range from the minimum luminance to the maximum luminance of the display 12. For example, the controller 14 sets all selectable numerical values or stages from the range from the lowest luminance to the highest luminance to one cycle. In one cycle, every time step S440 in FIG. 8 is executed, the controller 14 selects a numerical value or a stage of the luminance from the range from the lowest luminance to the highest luminance so as to be random and not to overlap. When there are no more selectable numerical values or stages, the next cycle starts and all numerical values or stages are also selectable.

In one embodiment, the controller 14 changes the luminance according to a predetermined change pattern within a range from the minimum luminance to the maximum luminance of the display 12. That is, in one cycle, every time step S440 in FIG. 8 is executed, the controller 14 selects a numerical value or a stage of the luminance according to the change pattern. Note that the change pattern can be set on the basis of the current time, season, location area, weather, or the like, and can be stored in the storage 13.

According to such control, in response to the read information not being acquired from the first image, different illumination environments are provided to the subject 20 by changing the luminance of the display 12 stepwise or randomly. Therefore, even if the analysis of the first image fails, the acquisition and analysis of the first image can be retried in different lighting environments, and the success rate of analysis is improved.

### Third Embodiment

### <Analysis by Plurality of First Images>

In a third embodiment, after acquiring a plurality of first images with different settings, the controller 14 can analyze the plurality of first images to acquire read information.

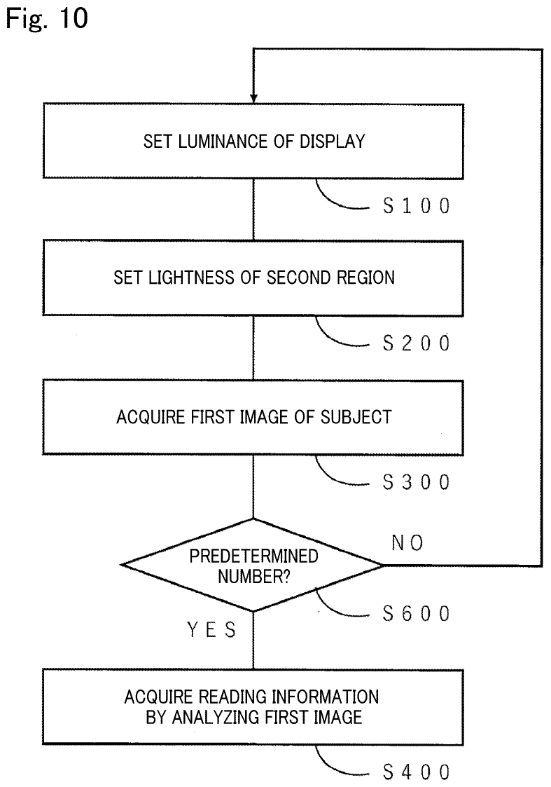

FIG. 10 is a flowchart of an example of a method for controlling an electronic device of the third embodiment. The third embodiment is different from the first embodiment in that a plurality of first images are acquired and analyzed and a plurality of first images are analyzed. The controller 14 repeatedly executes steps S100 to S300 until acquiring a predetermined number of first images in one cycle, and the predetermined number of first images is two or more.

In one embodiment, each of the predetermined number of first images is captured with different luminance and lightness. For this purpose, the controller 14 sets the luminance of the display 12 so as to change the luminance stepwise or randomly within one cycle, and further sets the lightness of the second region R2 according to the set luminance (step S200). Similarly to the second embodiment, the controller 14 can change the luminance stepwise or randomly within a range from the minimum luminance to the maximum luminance of the display 12.

In a case where the number of first images acquired with different settings having reached the predetermined number (“YES” in step S600), the controller 14 analyzes the predetermined number of first images and acquires the reading information from the one-dimensional code or the like included in the first image.

According to such control, even in response to it being unclear whether a one-dimensional code or the like is not included in a part of the first images, the first images can be compensated by the other first images, and the success rate of analysis can be improved.

### Fourth Embodiment

### <Luminance Setting by Preview Screen>

In a fourth embodiment, before acquiring a first image for analysis, the controller 14 acquires a second image, and sets the luminance of the display 12 and the lightness of the second region R2 on the basis of the second image. An appropriate setting can improve the success rate of analysis.

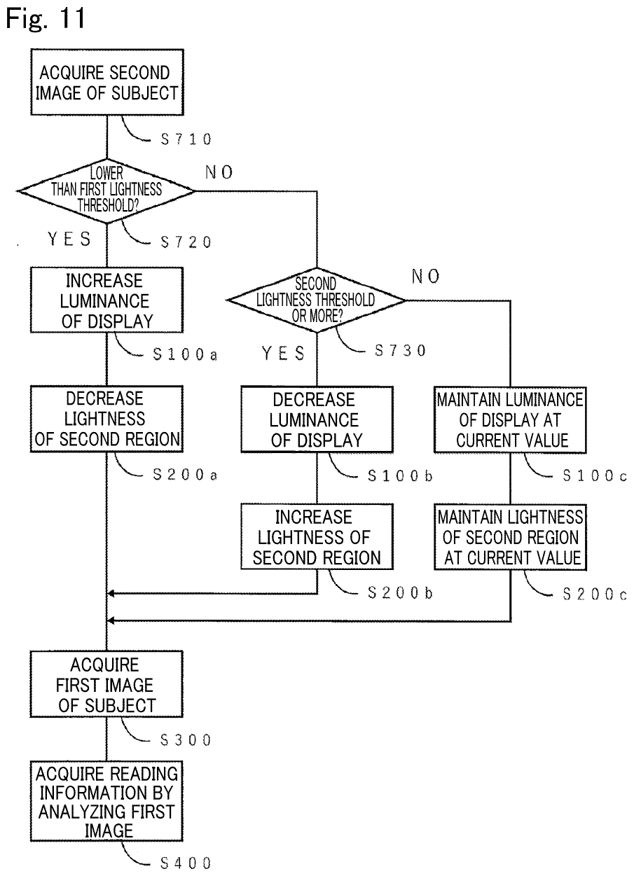

FIG. 11 is a flowchart of an example of a method for controlling an electronic device of the fourth embodiment. The contents of steps S300 and S400 in FIG. 11 are similar to those of steps S300 and S400 in FIG. 4 of the first embodiment, and the detailed description thereof will be omitted.

In the fourth embodiment, the controller 14 causes the imaging device 11 to acquire the second image displayable on the preview screen (step S710). In one example, the second image is an image (through image) to be displayed on the preview screen of the third region R3. In another example, the second image is an image for assisting the setting of the luminance of the display 12 and the lightness of the second region R2, and is not displayed on the display 12.

The controller 14 calculates the lightness of the acquired second image, and determines whether the lightness of the second image is lower than a first lightness threshold (step S720). In response to the lightness of the second image being lower than the first lightness threshold, there is a possibility that the one-dimensional code or the like included in the image is too dark and the analysis fails. Therefore, in this case, the controller 14 increases the luminance of the display 12 (step S100a), and decreases the lightness of the second region R2 on the basis of the increased luminance (step S200a). Subsequently, the controller 14 acquires the first image with the increased luminance (step S300). Compared with the second image, the first image is captured in a relatively bright environment, and thus has relatively high lightness and is relatively suitable for analysis.

In response to the lightness of the second image being equal to or higher than the first lightness threshold, the controller 14 further determines whether the lightness of the second image is equal to or higher than a second lightness threshold (step S730), and the second lightness threshold is higher than the first lightness threshold. In response to the lightness of the second image being equal to or higher than the second lightness threshold, there is a possibility that the one-dimensional code or the like included in the image is too bright and the analysis fails. Therefore, in this case, the controller 14 decreases the luminance of the display 12 (step S100b), increases the lightness of the second region R2 on the basis of the decreased luminance (step S200b), and acquires the first image (step S300). Compared with the second image, the first image is captured in a relatively dark environment, and thus has relatively low lightness and is relatively suitable for analysis.

In addition, in response to the lightness of the second image being equal to or higher than the first lightness threshold value and lower than the second lightness threshold value, it is considered that the one-dimensional code or the like included in the image is not too dark and not too bright, and is in a state of being easy to analyze. Therefore, in this case, the controller 14 acquires the first image in a state where the luminance of the display 12 is maintained at the current value (step S100c) and the lightness of the second region R2 is also maintained at the current value (step S200c) (step S300).

When the luminance of the display 12 and the lightness of the second region R2 are set in this manner, the first image for analysis has appropriate lightness. Therefore, the success rate of analysis of the one-dimensional code or the like included in the first image can be improved.

### Fifth Embodiment

### <Countermeasure Against Halation>

In a fifth embodiment, the controller 14 can reduce the possibility of acquiring a halation image and improve the success rate of analysis of the read information.

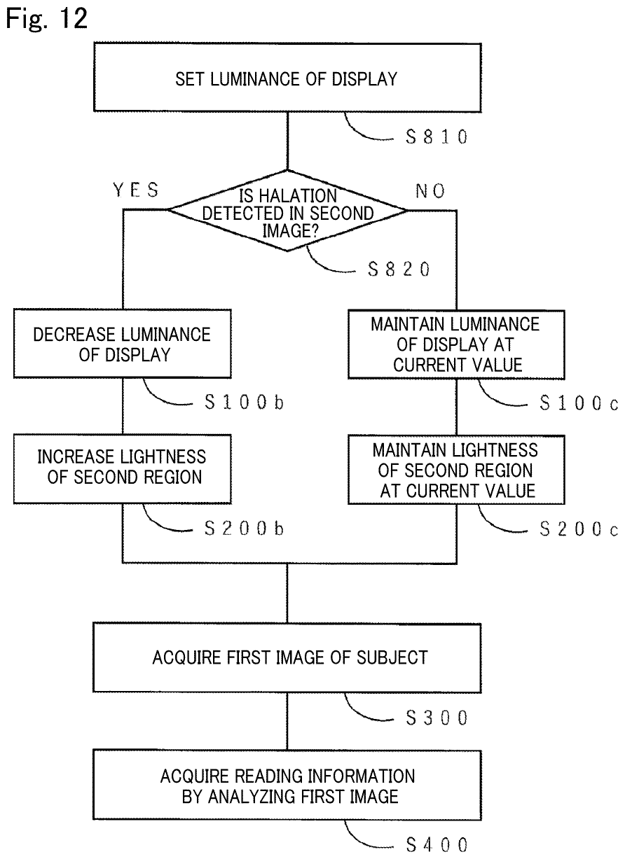

FIG. 12 is a flowchart of an example of a method for controlling an electronic device of the fifth embodiment. The contents of steps S300 and S400 in FIG. 12 are the same as the contents of steps S300 and S400 in FIG. 4 of the first embodiment, and the contents of steps S100b, S100c, S200b, and S200c in FIG. 12 are the same as the contents of steps S100b, S100c, S200b, and S200c in FIG. 11 of the fourth embodiment, so that the detailed description thereof is omitted.

Before acquiring the first image for analysis, the controller 14 acquires the second image of the subject 20 in order to determine whether halation may occur (step S810). The second image can be displayed on the preview screen after acquisition, but may not be displayed on the display 12.

The controller 14 determines whether any halation is detected in the second image (step S820). The halation indicates that gradation of a bright portion in an image is lost and the lost part becomes white due to excessive illumination or reflection. The controller 14 can detect halation by analyzing a histogram or RGB values of pixels of the second image. In one example, in response to detecting a small amount of extremely bright portion in the histogram of the pixels of the second image, the controller 14 determines that halation is detected in the second image. In another example, in response to a ratio of pixels whose RGB values being all 255 in the entire second image, exceeds a predetermined ratio, the controller 14 determines that halation is detected in the second image. Note that other halation detection techniques are also applicable to the present disclosure.

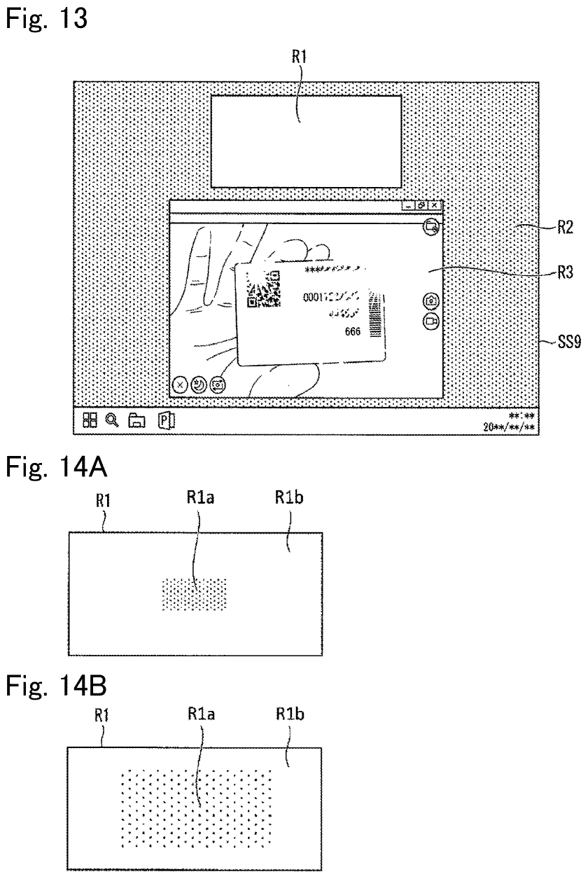

FIG. 13 is a schematic view illustrating halation of the fifth embodiment. The second image displayed in the third region R3 on a screen SS9 of FIG. 13 is entirely white, and the outline and gradation of some objects are lost and become white. Since halation is detected in the two-dimensional code included in the second image, the content of at least of a part of the two-dimensional code becomes invisible. Even if such a two-dimensional code is analyzed, the read information cannot be correctly acquired, and the analysis may fail.

In response to detecting halation in the second image, it is conceivable that excessive illumination or reflection is applied to the subject 20. Therefore, the controller 14 performs steps S100b and S200b, decreases the luminance of the display 12, and then acquires the first image for analysis. On the other hand, in response to detecting no halation in the second image, the controller 14 may perform steps S100c and S200c to acquire the first image for analysis using the current setting value.

Note that the controller 14 can also determine whether halation is detected in the first image. In response to detecting halation in the first image, the controller 14 decreases the luminance of the display 12 to increase the lightness of the second region, and then re-acquires and analyzes the first image again.

When halation is detected, the luminance of the display 12 is reduced, and then the first image for analysis is acquired, whereby the possibility that halation occurs in the first image is reduced, and the success rate of analysis can be improved.

### Sixth Embodiment

### <Example of Change in First Region R1>

As described above, the first region R1 can be filled with at least one color such as white. That is, the controller 14 may display one or more colors in the first region R1. In a sixth embodiment, in order to improve a situation in which the user feels dazzled or to reduce halation, the controller 14 can set various patterns for the lightness of the first region R1.

In one example, the user can designate the pattern of the first region R1. The controller 14 acquires a user input including pattern designation, and displays the designated pattern in the first region R1. In another example, the controller 14 automatically selects a color or a pattern of the first region R1 on the basis of a current time, a season, a location area, weather, or the like, and displays the color or the pattern in the first region R1.

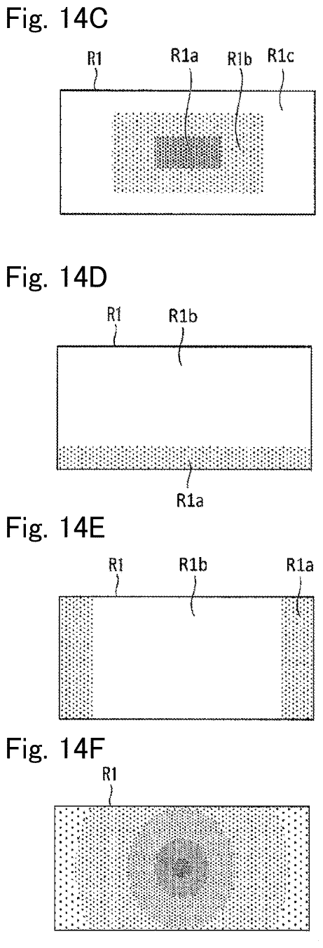

FIGS. 14A to 14F are schematic views illustrating an example of the first region R1 of the sixth embodiment. Among them, as illustrated in FIGS. 14A to 14E, the first region R1 may include a plurality of sub-regions having different lightness.

In the pattern illustrated in FIG. 14A, the first region R1 includes a first sub-region R1a and a second sub-region R1b having different lightness. The first sub-region R1a is provided at the center of the first region R1. The second sub-region R1b is provided so as to surround the first sub-region R1a. The lightness of the first sub-region R1a is lower than the lightness of the second sub-region R1b. That is, there is an area having relatively low lightness at the center of the first region R1. If such a pattern is used, the illumination light provided to the center of the subject 20 is less than the illumination light provided to the periphery of the subject 20. In such an illumination environment, the possibility of occurrence of halation in the first image or the second image is reduced, and the success rate of analysis of the first image can be improved. In addition, by displaying the first sub-region R1a having a relatively low lightness, it is possible to improve a situation in which the user feels dazzled.

In the pattern illustrated in FIG. 14B, the first region R1 includes a relatively bright first sub-region R1a and a relatively dark second sub-region R1b surrounding the first sub-region R1a. The pattern of FIG. 14B is different from the pattern of FIG. 14A in that the lightness of the second sub-region R1b is high and the size of the second sub-region R1b is large.

In the pattern illustrated in FIG. 14C, the first region R1 includes a first sub-region R1a provided at the center of the first region R1, a second sub-region R1b surrounding the first sub-region R1a, and a third sub-region R1c surrounding the second sub-region R1b. The lightness of the first sub-region R1a is lower than the lightness of the second sub-region R1b, and the lightness of the second sub-region R1b is lower than the lightness of the third sub-region R1c.

Note that the patterns in FIGS. 14A to 14C are formed such that a plurality of rectangles are overlapped to be dark from the outside to the inside, but the first region R1 may include a sub-region of another shape, and the positions of the plurality of sub-regions may be shifted from each other without being aligned.

In the pattern illustrated in FIG. 14D, the first region R1 includes a relatively bright first sub-region R1a and a relatively dark second sub-region R1b. The relatively dark second sub-region R1b is provided not at the center of the first region R1 but along a part of the side edge of the first region R1. In the example illustrated in FIG. 14D, the second sub-region R1b is provided so as to be in contact with the bottom edge of the first region R1. When the user holds the subject 20 and causes the imaging device 11 to perform reading, in the first region R1, a side edge portion is more likely to enter the eyes of the user than a central portion. Therefore, by providing the relatively dark second sub-region R1b in at least a part of the side edge of the first region R1, it is possible to improve the situation in which the user feels dazzled.

In the pattern illustrated in FIG. 14E, the first region R1 includes a relatively bright first sub-region R1a and relatively dark second sub-regions R1b provided at a side edge of the first region R1. The pattern of FIG. 14E is different from the pattern of FIG. 14D in that there are a plurality of second sub-regions R1b and the second sub-regions R1b are provided so as to be in contact with the left and right side edges of the first region R1.

In the pattern illustrated in FIG. 14F, the first region R1 includes gradation in which the lightness decreases from the side edge toward the center. The gradation with varying lightness may be a linear gradation, a radial gradation, or a gradation with other variations. In addition, the area having the lowest lightness in the gradation may be at the center, the side edge, or another position of the first region R1.

The controller 14 can select an appropriate pattern from various patterns on the basis of user's designation, the current time, and the surrounding environment, and display the selected pattern in the first region R1. According to these patterns, even in various environments, a comfortable visual experience can be provided to the user by reducing halation, improving a success rate of analysis, or improving a glare situation.

### Seventh Embodiment

### <Control Related to Third Region R3>

In response to the preview screen of the imaging device 11 being displayed in the third region R3 of the display 12, the user may feel dazzled by the brightness of the third region R3 depending on the luminance of the display 12 or the surrounding environment of the electronic device 10. In the seventh embodiment, the controller 14 controls the third region R3 so as to improve the situation in which the user feels dazzled.

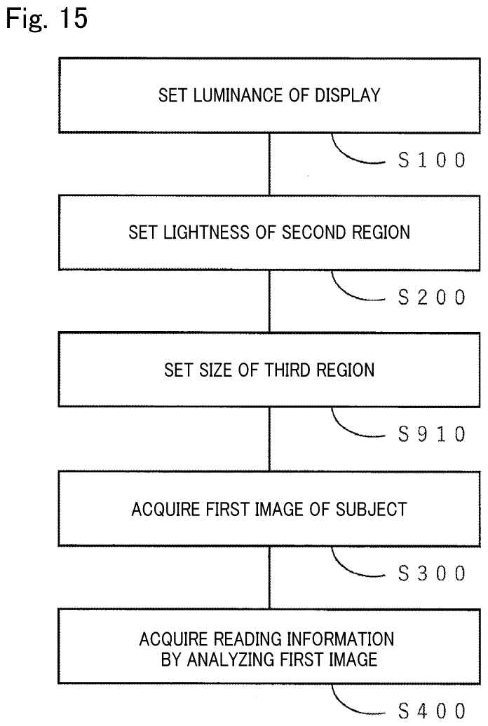

In one embodiment, the controller 14 reduces the third region R3 to improve the situation in which the user feels dazzled. FIG. 15 is a flowchart of an example of a method for controlling an electronic device of the seventh embodiment. The contents of steps S100 to S400 of FIG. 15 are similar to those of steps S100 to S400 of FIG. 4 of the first embodiment, and the detailed description will be omitted.

In the method for controlling an electronic device, the controller 14 can change the size of the third region R3 on the basis of the luminance of the display 12. In one example, the controller 14 sets the size of the third region R3 such that the size of the third region R3 decreases as the luminance of the display 12 increases (step S910). In response to the second region R2 being set as a region excluding the third region R3 and the like from the displayable region of the display 12, the size of the second region R2 changes according to a change in the size of the third region R3.

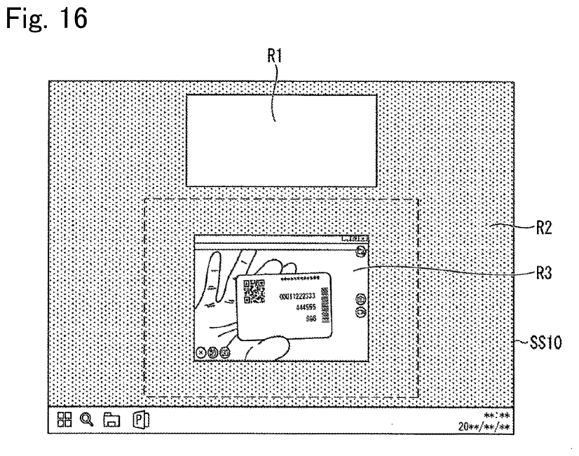

FIG. 16 is a schematic view illustrating an example of the third region R3 of the seventh embodiment. In a screen SS10 of FIG. 16, the size of the third region R3 before the change is indicated by a dashed rectangle. In the example shown in FIG. 16, the second region R2 and the third region R3 do not overlap. When the luminance of the display 12 is high, the user easily feels dazzled with respect to the display 12. The controller 14 increases the luminance of the display 12 and decreases the lightness of the second region R2 to reduce the size of the third region R3. Since the lightness of the second region R2 decreases and the third region R3 decreases and the second region R2 of the background portion increases, the glare felt by the user is reduced.

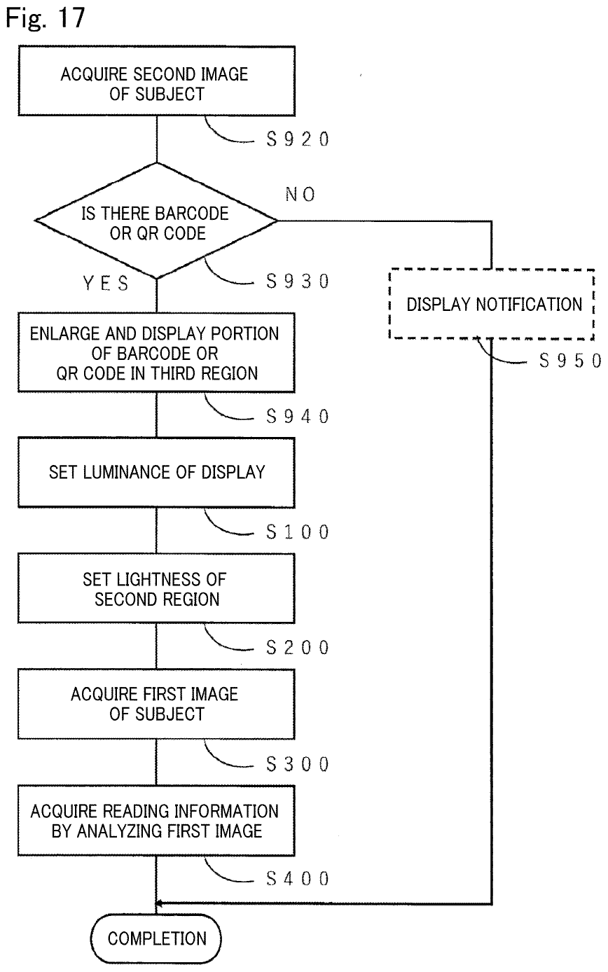

In one embodiment, the controller 14 improves the situation in which the user feels dazzled by reducing the bright portion in the third region R3. FIG. 17 is a flowchart illustrating another example of the method for controlling an electronic device of the seventh embodiment. The contents of steps S100 to S400 of FIG. 17 are similar to those of steps S100 to S400 of FIG. 4 of the first embodiment, and the detailed description will be omitted.

In the method for controlling an electronic device, the controller 14 acquires the second image displayable on the preview screen (step S920), and determines whether the second image has the one-dimensional code or the two-dimensional code (step S930). That is, the controller 14 determines whether or not the one-dimensional code or the two-dimensional code has been detected from the second image. In response to the one-dimensional code or the two-dimensional code being detected from the second image, the controller 14 enlarges a portion of the detected code and displays the portion in the third region R3 (step S940). Generally, since the one-dimensional code or the two-dimensional code includes many black portions, the lightness of the entire code is low. Even when the luminance of the display 12 increases, if the portion of the code is enlarged and displayed, a portion having low lightness occupies a large proportion in the third region R3, and the entire third region R3 looks relatively dark.

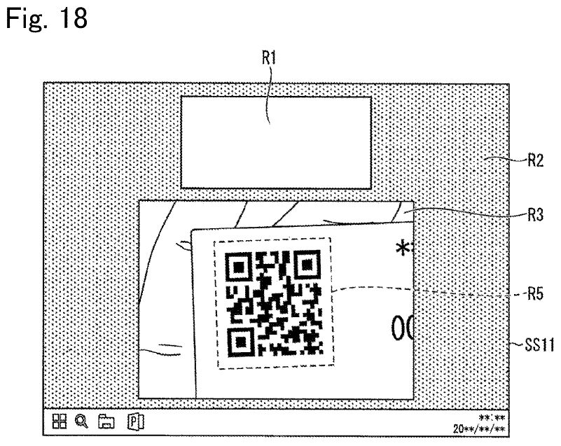

FIG. 18 is a schematic view illustrating an example of the third region R3 of the seventh embodiment. The QR code is enlarged and displayed in the third region R3 of a screen SS11 of FIG. 18. Therefore, even if the luminance of the display 12 increases, the entire third region R3 looks relatively dark, and the glare felt by the user is alleviated. In addition, the enlarged one-dimensional code or two-dimensional code makes it easy for the user to recognize the state of the one-dimensional code or the two-dimensional code.

On the other hand, in response to the one-dimensional code or the two-dimensional code not existing in the second image, it is not possible to analyze the one-dimensional code or the two-dimensional code to acquire the read information. In this case, the controller 14 causes the display 12 to display a notification indicating that the one-dimensional code or the like is not detected (step S950). This notification prompts the user to change the position and angle of the subject 20 so that the one-dimensional code or the two-dimensional code is captured.

By controlling the size or display content of the third region R3 in this manner, it is possible to alleviate the brightness felt by the user with respect to the third region R3.

Note that the present disclosure also provides a computer program and a storage medium for a method for controlling the electronic device 10, which correspond to the second to seventh embodiments.

The configurations of the above-described first to seventh embodiments can be combined. For example, the configuration of any one of the second to fourth embodiments and the configuration of at least one of the first and fifth to seventh embodiments can be combined.

### Other Embodiments

### (Supplementary Notes)

The following technique is disclosed by the above description of the embodiments.

(Technology 1) An electronic device comprising: an imaging device that images a subject; a display that is provided on the same side as the imaging device in the electronic device and displays a first region that irradiates the subject with illumination light and a second region that does not overlap with the first region; and a controller that controls the imaging device and the display; wherein the controller sets luminance of the display, sets lightness of the second region on a basis of the luminance of the display, acquires a first image of the subject by the imaging device, and acquires read information by analyzing the first image.

According to such an electronic device, it is possible to provide a comfortable visual experience without giving a sense of discomfort to the user with respect to the brightness of the entire display 12 while providing the illumination light to the subject 20 via the first region R1.

(Technology 2) The electronic device according to Technology 1, wherein the subject is an object including a one-dimensional code, an object including a two-dimensional code, or an identification card, and the read information includes a character string coded in the one-dimensional code, a character string coded in the two-dimensional code, or a character string written on the identification card.

According to such an electronic device, various one-dimensional codes, two-dimensional codes, or character strings can be analyzed.

(Technology 3) The electronic device according to Technology 1 or 2, wherein the controller sets the lightness of the second region such that the lightness of the second region decreases as the luminance of the display increases.

According to such an electronic device, even if the luminance becomes relatively high, the brightness of the entire display 12 can be suppressed, and a comfortable visual experience can be provided to the user.

(Technology 4) The electronic device according to Technology 3, wherein the controller sets the lightness of the second region on a basis of the luminance of the display so as not to give a sense of discomfort to a user with respect to brightness of the entire display.

According to such an electronic device, it is possible to provide a comfortable visual experience without giving a sense of discomfort to the user with respect to the brightness of the entire display.

(Technology 5) The electronic device according to Technology 4, wherein the controller sets lightness of the second region on a basis of the luminance of the display such that a change in brightness of the entire display falls within a predetermined range.

According to such an electronic device, a change in brightness of the entire display is suppressed, and a comfortable visual experience can be provided to the user.

(Technology 6) The electronic device according to any one of Technologies 1 to 5, wherein, in response to the read information not being acquired by analyzing the first image, the controller further: changes luminance stepwise or randomly within a range from minimum luminance to maximum luminance of the display; changes the lightness of the second region on a basis of the changed luminance; acquires a first image of the subject by the imaging device with the changed luminance and lightness; and acquires the read information by analyzing the first image acquired with the changed luminance and lightness.

According to such an electronic device, even if the analysis of the first image fails, different illumination environments can be provided, and the acquisition and analysis of the first image by the different illumination environments can be retried, and the success rate of analysis is improved.

(Technology 7) The electronic device according to Technology 6, wherein in response to the read information not being acquired by analyzing the first image and the luminance of the display is the maximum luminance, the controller decreases the luminance of the display and increase the lightness of the second region, and in response to the read information not being acquired by analyzing the first image and the luminance of the display is not the maximum luminance, the controller increases the luminance of the display and decrease the lightness of the second region.

According to such an electronic device, it is possible to efficiently change the luminance within a range from the minimum luminance to the maximum luminance of the display 12 so that the setting value does not overlap.

(Technology 8) The electronic device according to any one of Technologies 1 to 5, wherein the controller sets different luminance and lightness of the second region based on the luminance, acquires a plurality of first images of the subject by the imaging device with different settings, and acquires the read information by analyzing the plurality of first images.

According to such an electronic device, analysis can be performed using a plurality of first images, and the success rate of analysis can be improved.

(Technology 9) The electronic device according to any one of Technologies 1 to 5, wherein when setting the luminance of the display, the controller acquires a second image displayable on a preview screen by the imaging device, increases the luminance of the display in response to the lightness of the second image being lower than a first lightness threshold, and decreases the luminance of the display in response to the lightness of the second image being equal to or higher than a second lightness threshold; and the second lightness threshold is higher than the first lightness threshold.

According to such an electronic device, the first image for analysis has appropriate lightness. Therefore, the success rate of analysis of the one-dimensional code or the like included in the first image can be improved.

(Technology 10) The electronic device according to any one of Technologies 1 to 9, wherein the controller further acquires a second image displayable on a preview screen by the imaging device, and decreases the luminance of the display and increases the lightness of the second region in response to detecting halation in the second image.

According to such an electronic device, it is possible to reduce the possibility of occurrence of halation even in the first image and to improve the success rate of analysis.

(Technology 11) The electronic device according to any one of Technologies 1 to 10, further comprising an illuminance sensor that is provided on the same side of the electronic device as the imaging device and detects illuminance around the electronic device; wherein the controller further sets the luminance of the display such that the luminance of the display increases as the detected illuminance decreases.

According to such an electronic device, it is possible to set luminance suitable for an illumination environment around the electronic device, and to improve the success rate of analysis.

(Technology 12) The electronic device according to any one of Technologies 1 to 11, wherein the first region includes a plurality of sub-regions having different lightness.

(Technology 13) The electronic device according to any one of Technologies 1 to 12, wherein the first region includes a first sub-region at a center of the first region and a second sub-region surrounding the first sub-region; and lightness of the first sub-region is lower than lightness of the second sub-region.

(Technology 14) The electronic device according to any one of Technologies 1 to 11, wherein the first region includes a gradation in which lightness decreases from a side edge toward a center.

According to such a first region, it is possible to improve a situation in which the user feels dazzled or a situation in which halation occurs.

(Technology 15) The electronic device according to any one of Technologies 1 to 14, further comprising an input device that acquires a user input for specifying a type of the subject; wherein the controller further acquires the user input by the input device, and sets at least one of a shape or a size of the first region on a basis of a type of the subject.

According to such an electronic device, the first region suitable for the type of the subject can be set, and the success rate of analysis can be improved.

(Technology 16) The electronic device according to any one of Technologies 1 to 15, wherein the display further displays a third region for displaying a preview screen; and the second region is a region acquired by excluding the first region from a displayable region of the display or a region acquired by excluding the first region and the third region from the displayable region of the display.

According to such an electronic device, by controlling the lightness of the second region R2, the brightness of the entire display 12 can be suppressed even if the luminance becomes relatively high, and a comfortable visual experience can be provided to the user.

(Technology 17) The electronic device according to any one of Technologies 1to 16, wherein the display further displays a third region for displaying a preview screen; and the controller further sets a size of the third region such that the size of the third region decreases as the luminance of the display increases.

According to such an electronic device, even if the luminance of the display increases, the third region decreases and the second region of the background portion increases, so that the glare felt by the user is reduced.

(Technology 18) The electronic device according to any one of Technologies 1to 17, wherein the display further displays a third region for displaying a preview screen; and the controller further acquires, by the imaging device, a second image displayable on the preview screen, and enlarges and displays, in response to the second image having a one-dimensional code or a two-dimensional code, the one-dimensional code or the two-dimensional code in the third region.

According to such an electronic device, even when the luminance of the display is high, the entire third region appears relatively dark, and the glare felt by the user is reduced.

(Technology 19) A control method for an electronic device, the electronic device including a display that displays a first region that irradiates a subject with illumination light and a second region that does not overlap the first region, and the control method comprising: setting luminance of the display; setting lightness of the second region on a basis of the luminance of the display; acquiring a first image of the subject by an imaging device of the electronic device; and acquiring read information by analyzing the first image.

(Technology 20) A non-transitory computer-readable storage medium having a computer program stored thereon, wherein when the computer program is executed by a processor, the control method of Technology 19 is implemented.

According to such a control method and storage medium, it is possible to provide a comfortable visual experience without giving a sense of discomfort to the user with respect to the brightness of the entire display 12 while providing the illumination light to the subject 20 via the first region R1.

The foregoing is merely specific embodiments of the present disclosure, and the protection scope of the present disclosure is not limited thereto. The present disclosure includes the contents described above in the drawings and the specific embodiments described above, but the present disclosure is not limited thereto. Various disclosed embodiments or examples may be combined without departing from the scope or spirit of the disclosure. Changes that do not depart from the functional and structural principles of the present disclosure are within the scope of the claims.

What is claimed is

1. An electronic device comprising:
an imaging device that images a subject;
a display that is provided on the same side as the imaging device in the electronic device and displays a first region that irradiates the subject with illumination light and a second region that does not overlap with the first region; and
a controller that controls the imaging device and the display, wherein the controller
sets luminance of the display,
sets lightness of the second region on a basis of the luminance of the display,
acquires a first image of the subject by the imaging device, and
acquires read information by analyzing the first image.

2. The electronic device according to claim 1, wherein
the subject is an object including a one-dimensional code, an object including a two-dimensional code, or an identification card, and
the read information includes a character string coded in the one-dimensional code, a character string coded in the two-dimensional code, or a character string written on the identification card.

3. The electronic device according to claim 1, wherein the controller sets the lightness of the second region such that the lightness of the second region decreases as the luminance of the display increases.

4. The electronic device according to claim 3, wherein the controller sets the lightness of the second region on a basis of the luminance of the display so as not to give a sense of discomfort to a user with respect to brightness of the entire display.

5. The electronic device according to claim 4, wherein the controller sets lightness of the second region on a basis of the luminance of the display such that a change in brightness of the entire display falls within a predetermined range.

6. The electronic device according to claim 1, wherein, in response to the read information not being acquired by analyzing the first image, the controller further:
changes luminance stepwise or randomly within a range from minimum luminance to maximum luminance of the display;
changes the lightness of the second region on a basis of the changed luminance;
acquires a first image of the subject by the imaging device with the changed luminance and lightness; and
acquires the read information by analyzing the first image acquired with the changed luminance and lightness.

7. The electronic device according to claim 6, wherein
in response to the read information not being acquired by analyzing the first image and the luminance of the display being at the maximum luminance, the controller decreases the luminance of the display and increases the lightness of the second region, and
in response to the read information not being acquired by analyzing the first image and the luminance of the display not being at the maximum luminance, the controller increases the luminance of the display and decreases the lightness of the second region.

8. The electronic device according to claim 1, wherein the controller
sets different luminance, and lightness of the second region based on the luminance,
acquires a plurality of first images of the subject by the imaging device with different settings, and
acquires the read information by analyzing the plurality of first images.

9. The electronic device according to claim 1, wherein when setting the luminance of the display, the controller
acquires a second image displayable on a preview screen by the imaging device,
increases the luminance of the display in response to the lightness of the second image being lower than a first lightness threshold, and
decreases the luminance of the display in response to the lightness of the second image being equal to or higher than a second lightness threshold; and
the second lightness threshold is higher than the first lightness threshold.

10. The electronic device according to claim 1, wherein the controller further
acquires a second image displayable on a preview screen by the imaging device, and
decreases the luminance of the display and increases the lightness of the second region in response to detecting halation in the second image.

11. The electronic device according to claim 1, further comprising an illuminance sensor that is provided on the same side of the electronic device as the imaging device and detects illuminance around the electronic device;
wherein the controller further sets the luminance of the display such that the luminance of the display increases as the detected illuminance decreases.

12. The electronic device according to claim 1, wherein the first region includes a plurality of sub-regions having different lightness.

13. The electronic device according to claim 1, wherein the first region includes a first sub-region at a center of the first region and a second sub-region surrounding the first sub-region; and lightness of the first sub-region is lower than lightness of the second sub-region.

14. The electronic device according to claim 1, wherein the first region includes a gradation in which lightness decreases from a side edge toward a center.

15. The electronic device according to claim 1, further comprising an input device that acquires a user input for specifying a type of the subject,
wherein the controller further
acquires the user input by the input device, and
sets at least one of a shape or a size of the first region on a basis of the type of the subject.

16. The electronic device according to claim 1, wherein the display further displays a third region for displaying a preview screen; and
the second region is a region acquired by excluding the first region from a displayable region of the display or a region acquired by excluding the first region and the third region from the displayable region of the display.

17. The electronic device according to claim 1, wherein the display further displays a third region for displaying a preview screen; and
the controller further sets a size of the third region such that the size of the third region decreases as the luminance of the display increases.

18. The electronic device according to claim 1, wherein the display further displays a third region for displaying a preview screen; and
the controller further
acquires, by the imaging device, a second image displayable on the preview screen, and
in response to the second image having a one-dimensional code or a two-dimensional code, enlarges and displays the one-dimensional code or the two-dimensional code in the third region.

19. A control method for an electronic device, the electronic device including a display that displays a first region that irradiates a subject with illumination light and a second region that does not overlap the first region, and the control method comprising:
setting luminance of the display;
setting lightness of the second region on a basis of the luminance of the display;
acquiring a first image of the subject by an imaging device of the electronic device; and
acquiring read information by analyzing the first image.

20. A non-transitory computer-readable storage medium having a computer program stored thereon, wherein when the computer program is executed by a processor, the control method of claim 19 is implemented.
